(19) United States
(12) Patent Application Publication
(10) Pub. No.: US 2009/0192277 A1
(43) Pub. Date: Jul. 30, 2009

(54) Method of producing cyclic olefin polymers having polar functional groups, olefin polymer produced using the method and optical anisotropic film comprising the same

(76) Inventors: Sung Cheol Yoon, Daejeon-city (KR); Young Chul Won, Kyungki-do (KR); Young Whan Park, Daejeon-city (KR); Sung Ho Chun, Daejeon-city (KR); Dai Seung Choi, Daejeon-city (KR); Won Kook Kim, Daejeon-city (KR); Tae Sun Lim, Daejeon-city (KR); Heon Kim, Jeollanam-do (KR); Jung Min Lee, Kyungsangbuk-do (KR); Kyung Lim Paik, Daejeon-city (KR)

Correspondence Address: MCKENNA LONG & ALDRIDGE LLP, 1900 K STREET, NW, WASHINGTON, DC, 20006, US

(21) Appl. No.: 10/585,358

(22) PCT Filed: Jul. 5, 2005
(86) PCT No.: PCT/KR05/02149

§ 371 Date: Jul. 6, 2006

(30) Foreign Application Priority Data
Jul. 7, 2004 (KR) 10-2004-0052612

(51) Int. Cl. C08F 4/80

(52) U.S. Cl. 526/171

(57) ABSTRACT

A method of producing a cyclic olefin polymer having a polar functional group and a high molecular weight with a high yield in which a catalyst is not deactivated due to polar functional groups, moisture and oxygen is provided. According to the olefin polymerization method, deactivation of a catalyst due to polar functional groups of monomers can be prevented, and thus a polyolefin having a high molecular weight can be prepared with a high yield, and the ratio of catalyst to monomer can be less than 1/5000 due to good activity of the catalyst, and thus removal of catalyst residues is not required.

### BACKGROUND OF THE INVENTION

1. Field of the Invention

The present invention relates to a method of producing cyclic olefin polymers, and more particularly, to a method of producing cyclic olefin polymers having polar functional groups using a catalyst composed of a Group 10 metal compound and a phosphonium salt compound, olefin polymers produced using the method, and an optical anisotropic film comprising the same.

2. Description of the Related Art

Inorganic materials such as silicon oxides or nitrides have been mainly utilized in the information and electronic industries. Recent technical developments and demands for compact and high efficiency devices need new high performance materials. In this respect, a great deal of attention has been paid to polymers which have desirable physicochemical properties such as low dielectric constant and moisture absorption rate, high adhesion to metals, strength, thermal stability and transparency, and a high glass transition temperature (T_{g}>250° C.).

Such polymers can be used as insulating layers of semiconductors or TFT-LCDs, protecting films for polarizing plates, multichip modules, integrated circuits (ICs), printed circuit boards, molding materials for electronic components or electronic materials for flat panel displays, etc.

As one of new performance materials, cyclic olefin polymers which are composed of cyclic olefin monomers such as norbornenes exhibit much more improved properties than conventional olefin polymers, in that they show high transparency, heat resistance and chemical resistance, and have a low birefringence and moisture absorption rate. Thus, they can be applied to various applications, e.g., optical components such as CDs, DVDs and POFs (plastic optical fibers), information and electronic components such as capacitor films and low-dielectrics, and medical components such as low-absorbent syringes, blister packagings, etc.

Cyclic olefin polymers are known to be prepared by one of the following three methods: ROMP (ring opening metathesis polymerization), copolymerization with ethylene, and addition polymerization using catalysts containing transition metals such as Ni and Pd. These methods are depicted in Reaction Scheme 1 below. Depending on the central metal, ligand and cocatalyst of a catalyst used in the polymerization reaction, polymerization characteristics and the structure and characteristics of polymers to be obtained may be varied.

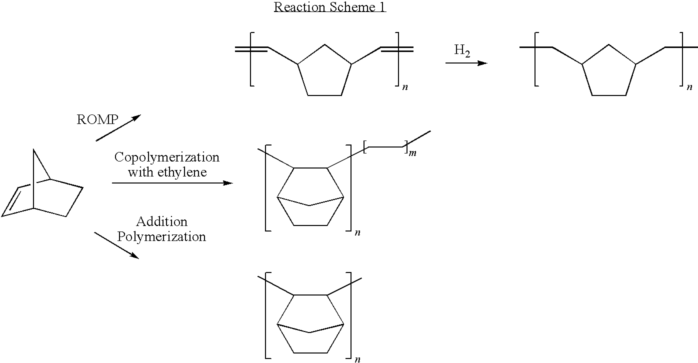

In ROMP, a metal chloride such as TiCl₄ or WCl₆ or a carbonyl-type organometallic compound reacts with a cocatalyst such as Lewis acid, R₃Al or Et₂AlCl to form active catalyst species such as a metal carbene or a metallocyclobutane which react with double bonds of olefin to provide a ring opened product having double bonds (Ivin, K. J.; O'Donnel, J. H.; Rooney, J. J.; Steward, C. D. Makromol. Chem. 1979, Vol. 180, 1975). A polymer prepared by the ROMP method has one double bond per one monomeric repeating unit, thus, the polymer has poor thermal and oxidative stability and is mainly used as thermosetting resins.

In order to improve physicochemical properties of polymers prepared by the ROMP method, a method of hydrogenation of the ROMP-polymer in the presence of Pd or Raney-Ni catalysts has been proposed. Hydrogenated polymer shows improved oxidative stability, but still needs to be improved in its thermal stability. Further, a cost increased due to additional processes is against its commercial application.

Ethylene-norbornene copolymers are known to be first synthesized using a titanium-based Ziegler-Natta catalyst by Leuna, Corp., (Koinzer, P. et al., DE Patent No. 109,224). However, impurities remaining in the copolymer deteriorates its transparency and its glass transition temperature (T_{g}) is very low, i.e., 140° C. or lower.

As to the addition polymerization of cyclic olefinic monomers, Gaylord et al. reported a polymerization of norbornene using [Pd(C₆H₅CN)Cl₂]₂ as a catalyst (Gaylord, N. G.; Deshpande, A. B.; Mandal, B. M.; Martan, M. J. Macromol. Sci.-Chem. 1977, A11(5), 1053-1070). Furthermore, Kaminsky et al. reported a homopolymerization of norbornene using a zirconium-based metallocene catalyst (Kaminsky, W.; Bark, A.; Drake, I. Stud. Surf. Catal. 1990, Vol. 56, 425). These polymers have a high crystallinity, thermally decompose at a high temperature before they melt, and are substantially insoluble in general organic solvents.

Adhesion of polymers to inorganic surfaces such as silicon, silicon oxide, silicon nitride, alumina, copper, aluminium, gold, silver, platinum, nickel, tantalium, and chromium is often a critical factor in the reliability of the polymer for use as electronic materials. The introduction of functional groups into norbornene monomers enables the control of chemical and physical properties of a resultant norbornene polymer.

U.S. Pat. No. 3,330,815 discloses a method of polymerizing norbornene monomers having a polar functional group. However, the catalyst is deactivated by polar functional groups of norbornene monomers, which results in an earlier termination of the polymerization reaction, thereby producing a norbornene polymer having a molecular weight of 10,000 or less.

U.S. Pat. No. 5,705,503 discloses a method of polymerizing norbornene monomers having a polar functional group using ((Allyl)PdCl)₂/AgSbF₆ as a catalyst. However, an excess of the catalyst is required (1/100 to 1/400 molar ratio relative to the monomer) and the removal of the catalyst residues after polymerization is difficult, which causes the transparency of the polymer to be deteriorated due to a subsequent thermal oxidation.

Sen et al. reported a method for polymerizing various ester norbornene monomers in the presence of a catalyst, [Pd(CH₃CN)₄][BF₄]₂, in which exo isomers were selectively polymerized, and the polymerization yield was low. (Sen et al., J. Am. Chem. Soc. 1981, Vol. 103, 4627-4629). In addition, a large amount of the catalyst is used (the ratio of catalyst to monomer is 1:100 to 1:400) and it is difficult to remove catalyst residues after the polymerization.

U.S. Pat. No. 6,455,650 issued to Lipian et al. discloses a method of polymerizing norbornene monomers having a functional group in the presence of a small amount of a catalyst, [(R′)_{z}M(L′)ₓ(L″)_{y}]_{b}[WCA]_{d}. However, the product yield in a polymerization of a polar monomer such as an ester-norbornene, is only 5%. Thus, this method is not suitable for the preparation of polymers having polar functional groups.

Sen et al. reported a method for polymerizing an ester-norbornene in the presence of a catalyst system including [(1,5-Cyclooctadiene)(CH₃)Pd(Cl)], PPh₃, and Na⁺[3,5-(CF₃)₂C₆H₃]₄B⁻, in which the polymerization yield of ester-norbornenes is 40% or lower, the molecular weight of the polymer is 6,500 or lower, and the molar amount of the catalyst used is about 1/400 based on the monomer (Sen et al., Organometallics 2001, Vol. 20, 2802-2812).

Therefore, there is still a demand for an addition-polymerization of cyclic olefins having polar functional groups which is able to meet a certain desired level in the aspect of polymerization yield, a molecular weight of a resultant polymer, and a molar ratio of a catalyst to monomers.

### SUMMARY OF THE INVENTION

The present invention provides a method for producing a cyclic olefin polymer having polar functional groups and a high molecular weight in a high yield by using a catalyst which is not deactivated due to polar functional groups, moisture and oxygen.

The present invention also provides a cyclic olefin polymer having polar functional groups, which has a high glass transition temperature and a desirable thermal and oxidative stability, a desirable chemical resistance and adhesion to metal.

The present invention also provides an optical anisotropic film made from a cyclic olefin polymer having polar functional groups.

According to an aspect of the present invention, there is provided a method of producing cyclic olefin polymers having polar functional groups, which comprises:

preparing a catalyst mixture including

i) a procatalyst represented by formula (1) containing a group 10 metal and a ligand containing hetero atoms bonded to the metal;

ii) a cocatalyst represented by formula (2) including a salt compound which is capable of providing a phosphonium cation and an anion weakly coordinating to the metal of the procatalyst; and

addition-polymerizing cyclic olefin monomers having polar functional groups in the presence of an organic solvent and the catalyst mixture, at a temperature of 80-150° C.:

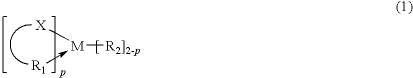

where X is a hetero atom selected from S, O and N;

R₁ is —CH═CHR²⁰, —OR²⁰, —SR²⁰, —N(R²⁰)₂, —N═NR²⁰, —P(R²⁰)₂, —C(O)R²⁰, —C(R²⁰)═NR²⁰, —C(O)OR²⁰, —OC(O)OR²⁰, —OC(O)R²⁰, —C(R²⁰)═CHC(O)R²⁰, —R²¹C(O)R²⁰, —R²¹C(O)OR²⁰ or —R²¹OC(O)R²⁰, in which R²⁰ is a hydrogen, a halogen, a linear or branched C₁₋₅ alkyl, a linear or branched C₁₋₅ haloalkyl, a linear or branched C₅₋₁₀ cycloalkyl, a linear or branched C₂₋₅ alkenyl, a linear or branched C₂₋₅ haloalkenyl, or an optionally substituted C₇₋₂₄ aralkyl, and R²¹ is a C₁₋₂₀ hydrocarbylene;

R₂ is a linear or branched C₁₋₂₀ alkyl, alkenyl or vinyl; a C₅₋₁₂ cycloalkyl optionally substituted by a hydrocarbon; a C₆₋₄₀ aryl optionally substituted by a hydrocarbon; a C₇₋₁₅ aralkyl optionally substituted by a hydrocarbon; or C₃₋₂₀ alkynyl;

M is a Group 10 metal; and

p is an integer from 0 to 2, and

[(R₃)—P(R₄)ₐ(R_{4′})_{b}[Z(R₅)_{d}]_{c}][Ani] (2)

where each of a, b and c is an integer from 0 to 3, and a+b+c=3;

Z is O, S, Si or N;

d is 1 when Z is O or S, d is 2 when Z is N, and d is 3 when Z is Si;

R₃ is a hydrogen, an alkyl, or an aryl;

each of R₄, R_{4′} and R₅ is a hydrogen; a linear or branched C₁₋₂₀ alkyl, alkoxy, allyl, alkenyl or vinyl; a C₃₋₁₂ cycloalkyl optionally substituted by a hydrocarbon; a C₆₋₄₀ aryl optionally substituted by a hydrocarbon; a C₇₋₁₅ aralkyl optionally substituted by a hydrocarbon; a C₃₋₂₀ alkynyl; a tri(linear or branched C₁₋₁₀ alkyl)silyl; a tri(linear or branched C₁₋₁₀ alkoxy)silyl; a tri(optionally substituted C₃₋₁₂ cycloalkyl)silyl; a tri(optionally substituted C₆₋₄₀ aryl)silyl; a tri(optionally substituted C₆₋₄₀ aryloxy)silyl; a tri(linear or branched C₁₋₁₀ alkyl)siloxy; a tri(optionally substituted C₃₋₁₂ cycloalkyl)siloxy; or a tri(optionally substituted C₆₋₄₀ aryl)siloxy, in which each substituent is a halogen or C₁₋₂₀ haloalkyl; and

[Ani] is an anion capable of weakly coordinating to the metal M of the procatalyst and is selected from the group consisting of borate, aluminate, [SbF₆]—, [PF₆]—, [AsF₆]—, perfluoroacetate([CF₃CO₂]—), perfluoropropionate([C₂F₅CO₂]—), perfluorobutyrate([CF₃CF₂CF₂CO₂]—), perchlorate([ClO₄]—),
p-toluenesulfonate([p-CH₃C₆H₄SO₃]—), [SO₃CF₃]—, boratabenzene, and carborane optionally substituted with a halogen.

According to another aspect of the present invention, there is provided a cyclic olefin polymer having a polar functional group, produced using the above method.

According to another aspect of the present invention, there is provided an optical anisotropic film including a cyclic olefin polymer having a polar functional group.

### BRIEF DESCRIPTION OF THE DRAWING

FIG. 1 represents a molecular structure of tricyclohexylphosphonium (tetrakispentafluorophenyl)borate.

### DETAILED DESCRIPTION OF THE INVENTION

A method of producing cyclic olefin polymers having polar functional groups according to an embodiment of the present invention includes: preparing a catalyst mixture including (i) a procatalyst represented by formula (1) containing a group 10 metal and a ligand containing hetero atoms bonded to the metal and (ii) a cocatalyst represented by formula (2) including a salt compound which is capable of providing a phosphonium cation and an anion weakly coordinating to the metal of the procatalyst; and addition-polymerizing cyclic olefin monomers having polar functional groups in the presence of an organic solvent and the catalyst mixture, at a temperature of 80-150° C.

In the present embodiment, the deactivation of a catalyst due to a polar functional group of the monomer, moisture and oxygen can be prevented, the catalyst is thermally and chemically stable, thereby a high yield and a high molecular weight of the cyclic olefin polymer can be achieved with a small amount of the catalyst and the removal process of the catalyst residue is not required.

In formula (1), an arrow represents that a hetero atom or C═C bond of a ligand coordinates to a metal, which is called the dative bond.

In the method, the procatalyst is very stable even in the presence of a monomer having a polar functional group, moisture and oxygen and the phosphonium cocatalyst does not generate an amine which is produced by the ammonium borate to poison the catalyst. Further, in the reaction of the procatalyst with the cocatalyst, a phosphine is formed to stabilize the cationic species, thereby inhibiting the deactivation of the catalyst by a polar functional group of a monomer, moisture and oxygen.

As to a polymerization temperature, in the case of general organometallic polymerization catalysts, when the polymerization temperature increases, the polymerization yield increases, whereas a molecular weight of a polymer decreases or catalysts lose the polymerization activity by thermal decomposition (Kaminsky et al. Angew. Chem. Int. Ed., 1985, vol 24, 507; Brookhart et al. Chem. Rev. 2000, vol 100, 1169; Resconi et al. Chem. Rev. 2000, vol 100, 1253).

Meanwhile, a polar group of a norbornene monomer interacts with the catalyst at room temperature to prevent the double bond of a norbornene from coordinating to an active site of the catalyst, thereby resulting in decrease in the polymerization yield and the molecular weight. However, when the polymerization temperature increases, the double bond of a norbornene is easy to insert into the metal-growing polymer chain bond to increase the activity and a β-hydrogen of a growing polymer chain bonded to the metal cannot form a stereo structural environment to be eliminated where it can interact with the catalyst in view of inherent properties of the norbornene monomer, thereby increasing the molecular weight of the polymer (Kaminsky et al. Macromol. Symp. 1995, vol 97, 225). Thus, it is necessary to increase the polymerization temperature. However, most catalysts conventionally used to produce polynorbornenes having polar functional groups tend to be decomposed at 80° C. or higher, and thus polymers having high molecular weights cannot be obtained in a high yield. However, the catalyst of the present embodiment is thermally stable not to be decomposed at 80° C. or higher and prevents the interaction between the polar functional group of the norbornene monomer and the cationic catalyst, and thus a catalyst active site can be formed or recovered, thereby producing a high molecular weight cyclic olefin polymer having a polar functional group in a high yield. When the polymerization temperature is higher than 150° C., catalyst components are decomposed in solution, and thus it is difficult to produce a cyclic olefin polymer having a polar functional group and a high molecular weight in a high yield.

According to the method of the present embodiment, when a polar functional group in a monomer is an acetyl group, a high yield in polymerization can be obtained with a high molecular weight, which is supported by Examples and Comparative Examples. The catalyst mixture is stable even in the presence of polar functional groups, moisture, oxygen, and other impurities. Thus, while conventional catalysts have good activity only in-situ and in the absence of air, the catalyst mixture of the present embodiment can be stored in a solution for a long period of time, the isolation of solvent is not required, and its activity is maintained even in air. Therefore, the method of the present embodiment can reproducibly be used under various preparation conditions, which is particularly important in industrial mass-production.

That is, the catalyst mixture including (i) a procatalyst represented by formula (1) containing a group 10 metal and a ligand containing hetero atoms bonded to the metal and (ii) a cocatalyst represented by formula (2) including a salt compound which is capable of providing a phosphonium cation and an weakly coordinating anion is not decomposed at the polymerization temperature of 80-150° C. and is stable in the presence of polar functional groups, moisture and oxygen, and shows high activity.

In the method, borate or aluminate of formula (2) may be an anion represented by formula (2a) or (2b):

[M′(R₆)₄] (2a),

[M′(OR₆)₄] (2b)

where M′ is B or Al; R₆ is each independently a halogen, a C₁₋₂₀ alkyl or alkenyl optionally substituted by a halogen, a C₃₋₁₂ cycloalkyl optionally substituted by a halogen, a C₆₋₄₀ aryl optionally substituted by a C₃₋₂₀ hydrocarbon, a C₆₋₄₀ aryl substituted by a linear or branched C₃₋₂₀ trialkylsiloxy or a linear or branched C₁₈₋₄₈ triarylsiloxy, or a C₇₋₁₅ aralkyl optionally substituted by a halogen.

The cyclic olefin monomer used in the method is a norbornene-based monomer having a polar functional group. A norbornene-based monomer or norbornene derivative means a monomer having at least one norbornene (bicyclo[2.2.2]hept-2-ene) unit. The norbornene-based monomer is represented by formula (3):

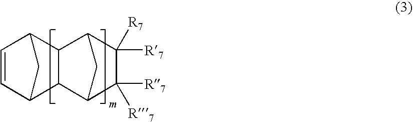

where m is an integer from 0 to 4; at least one of R₇, R₇′, R₇″ and R₇′″ is a polar functional group and the others are nonpolar functional groups; R₇, R₇′, R₇″ and R₇′″ can be bonded together to form a saturated or unsaturated C₄₋₁₂ cyclic group or a C₆₋₂₄ aromatic ring, in which the nonpolar functional group is a hydrogen, a halogen, a linear or branched C₁₋₂₀ alkyl, haloalkyl, alkenyl or haloalkenyl, a linear or branched C₃₋₂₀ alkynyl or haloalkynyl, a C₃₋₁₂ cycloalkyl optionally substituted by an alkyl, an alkenyl, an alkynyl, a halogen, a haloalkyl, a haloalkenyl or haloalkynyl, a C₆₋₄₀ aryl optionally substituted by an alkyl, an alkenyl, an alkynyl, a halogen, a haloalkyl, a haloalkenyl or haloalkynyl, or a C₇₋₁₅ aralkyl optionally substituted by an alkyl, an alkenyl, an alkynyl, a halogen, a haloalkyl, a haloalkenyl or haloalkynyl; and the polar functional group is a non-hydrocarbonaceous polar group having at least one O, N, P, S, Si or B and is —R⁸OR⁹, —OR⁹, —OC(O)OR⁹, —R⁸OC(O)OR⁹, —C(O)R⁹, —R⁸C(O)OR⁹, —C(O)OR⁹, —R⁸C(O)R⁹, —OC(O)R⁹, —R⁸OC(O)R⁹, —(R⁸O)ₖ-OR⁹, —(OR⁸)ₖ-OR⁹, —C(O)—O—C(O)R⁹, —R⁸C(O)—O—C(O)R⁹, —SR⁹, —R⁸SR⁹, —SSR⁸, —R⁸SSR⁹, —S(═O)R⁹, —R⁸S(═O)R⁹, —R⁸C(═S)R⁹, —R⁸C(═S)SR⁹, —R⁸SO₃R⁹, —SO₃R⁹, —R⁸N═C═S, —NCO, R⁸—NCO, —CN, —R⁸CN, —NNC(═S)R⁹, —R⁸NNC(═S)R⁹, —NO₂, —R⁸NO₂,

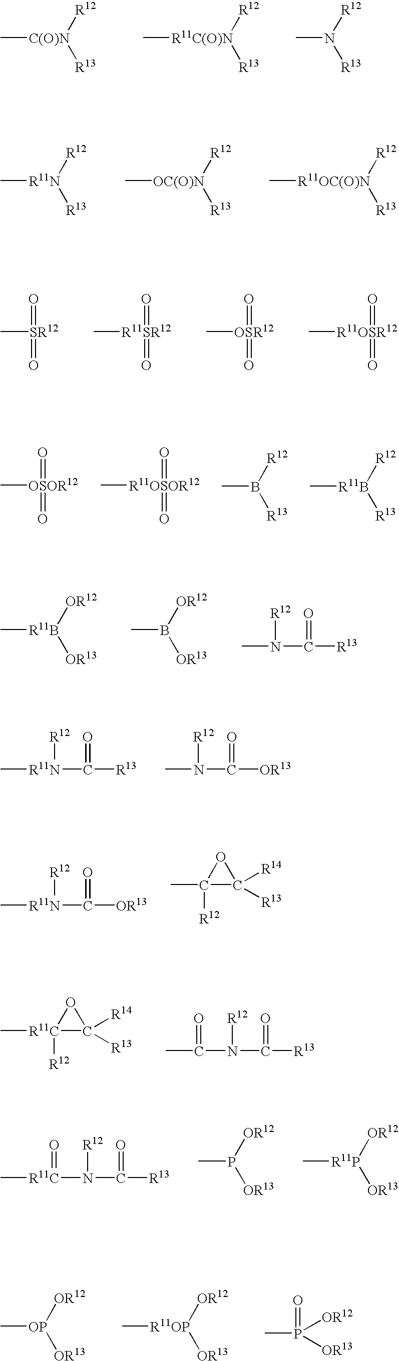

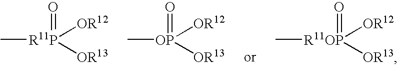

which each of R⁸ and R¹¹ is a linear or branched C₁₋₂₀ alkylene, haloalkylene, alkenylene or haloalkenylene, a linear or branched C₃₋₂₀ alkynylene or haloalkynylene, a C₃₋₁₂ cycloalkylene optionally substituted by an alkyl, an alkenyl, an alkynyl, a halogen, a haloalkyl, a haloalkenyl or haloalkynyl, a C₆₋₄₀ arylene optionally substituted by an alkyl, an alkenyl, an alkynyl, a halogen, a haloalkyl, a haloalkenyl or haloalkynyl, or a C₇₋₁₅ aralkylene optionally substituted by an alkyl, an alkenyl, an alkynyl, a halogen, a haloalkyl, a haloalkenyl or haloalkynyl; each of R⁹, R¹⁰, R¹² and R¹³ is a hydrogen, a halogen, a linear or branched C₁₋₂₀ alkyl, haloalkyl, alkenyl or haloalkenyl, a linear or branched C₃₋₂₀ alkynyl or haloalkynyl, a C₃₋₁₂ cycloalkyl optionally substituted by an alkyl, an alkenyl, an alkynyl, a halogen, a haloalkyl, a haloalkenyl or haloalkynyl, a C₆₋₄₀ aryl optionally substituted by an alkyl, an alkenyl, an alkynyl, a halogen, a haloalkyl, a haloalkenyl or haloalkynyl, a C₇₋₁₅ aralkyl optionally substituted by an alkyl, an alkenyl, an alkynyl, a halogen, a haloalkyl, a haloalkenyl or haloalkynyl, or an alkoxy, an haloalkoxy, a carbonyloxy or a halocarbonyloxy; and k is an integer from 1 to 10.

In the method of the present embodiment, the procatalyst represented by formula (1) and the cocatalyst represented by formula (2) may be a compound represented by formula (4) and a compound represented by formula (5), respectively;

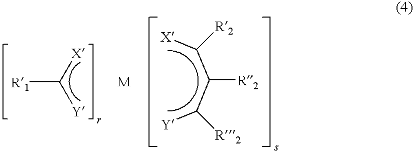

where each of X′ and Y′ is a hetero atom selected from S and O; each of R₁′, R₂′, R₂″ and R₂′″ is a linear or branched C₁₋₂₀ alkyl, alkenyl or vinyl, a C₅₋₁₂ cycloalkyl optionally substituted by a hydrocarbon, a C₆₋₄₀ aryl optionally substituted by a hydrocarbon, a C₇₋₁₅ aralkyl optionally substituted by a hydrocarbon, or a C₃₋₂₀ alkynyl; M is a Group 10 metal; and each of r and s is an integer from 0 to 2 and r+s=2, and

[H—P(R₄)₃][Ani] (5)

where R₄ is a hydrogen, a linear or branched C₁₋₂₀ alkyl, alkoxy, allyl, alkenyl or vinyl, an optionally substituted C₃₋₁₂ cycloalkyl, an optionally substituted C₆₋₄₀ aryl, an optionally substituted C₇₋₁₅ aralkyl, or a C₃₋₂₀ alkynyl, in which each substituent is a halogen or a C₁₋₂₀ haloalkyl; and [Ani] is an anion capable of weakly coordinating to the metal M of the procatalyst represented by formula (1) and is selected from the group consisting of borate, aluminate, [SbF₆]—, [PF₆]—, [AsF₆]—,
perfluoroacetate([CF₃CO₂]—), perfluoropropionate([C₂F₅CO₂]—),
perfluorobutyrate([CF₃CF₂CF₂CO₂]—), perchlorate([ClO₄]—),
p-toluenesulfonate([p-CH₃C₆H₄SO₃]—), [SO₃CF₃]—, boratabenzene, and carborane optionally substituted by a halogen.

In the method of the present embodiment, the procatalyst represented by formula (1) and the cocatalyst represented by formula (2) may be a palladium compound represented by formula (4a) and a phosphonium compound represented by formula (5), respectively;

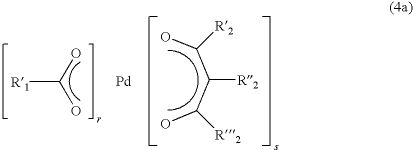

where each of R₁′, R₂′, R₂″ and R₂′″ is a linear or branched C₁₋₂₀ alkyl, alkenyl or vinyl, a C₅₋₁₂ cycloalkyl optionally substituted by a hydrocarbon, a C₆₋₄₀ aryl optionally substituted by a hydrocarbon, a C₇₋₁₅ aralkyl optionally substituted by a hydrocarbon, or a C₃₋₂₀ alkynyl; and each of r and s is an integer from 0 to 2 and r+s=2, and

[H—P(R₄)₃][Ani] (5)

where R₄ and [Ani] are as defined above.

In the method of the present embodiment, in the procatalyst represented by formula (1), the metal is Pd, p is 2, and the ligand having a hetero atom directly coordinating to Pd is acetylacetonate or acetate, and in the cocatalyst including a salt compound having a phosphonium represented by formula (2), b is 0, c is 0, R₃ is H, and R₄ is cyclohexyl, isopropyl, t-butyl, n-butyl or ethyl.

The phosphonium compound used as the cocatalyst in the method has an electronically stabilizing ability and thermally and chemically activates transition metal compounds. In the method, the molar ratio of the cocatalyst to the procatalyst containing group 10 transition metal is in the range of 0.5:1-10:1. When the molar ratio of the cocatalyst to the procatalyst is less than 0.5:1, the effect of activating the procatalyst is inefficient. When the molar ratio of the cocatalyst to the procatalyst is greater than 10:1, an excess of phosphonium compound coordinates to the metal to prevent a norbornene monomer from coordinating to the metal and the cationic catalyst active species is too electronically stabilized to interact with the double bond of a norbornene monomer, thereby resulting in decreasing both polymerization yield and molecular weight.

The catalyst mixture including the procatalyst and the cocatalyst may be supported on an inorganic support. The inorganic support may be silica, titania, silica/chromia, silica/chromia/titania, silica/alumina, aluminum phosphate gel, silanized silica, silica hydrogel, montmorillonite clay or zeolite. When the catalyst mixture is supported on an inorganic support, a molecular weight distribution of a polymer can be controlled by selecting inorganic support and the polymer morphology can be improved.

The catalyst mixture can be directly used in a solid phase without a solvent or can be mixed in a solvent to form a preformed catalyst in the form of a mixture or a complex of the respective catalyst components, i.e. the group 10 metal compound and the phosphonium compound. Further, each catalyst components can be directly added into the polymerization reaction system without being preformed. When the catalyst mixture is dissolved in a solvent, dichloromethane, dichloroethane, toluene, chlorobenzene or a mixture thereof can be used as the solvent.

The total amount of the organic solvent in the reaction system may be 50-800%, and preferably 50-400%, by weight of based on the total monomer in the monomer solution. When the total amount of the organic solvent in the reaction system is less than 50% based on the weight of the total monomer in the monomer solution, the mixing in the polymerization reaction is difficult due to high viscosity of the polymer solution. When the total amount of the organic solvent in the reaction system is greater than 800% based on the weight of the total monomer in the monomer solution, both the polymerization yield and the molecular weight are reduced due to slow polymerization rate.

In the polymerization reaction system, the molar ratio of the catalyst mixture based on the Group 10 transition metal compound to the monomers contained in the monomer solution is in the range of 1:2,500-1:200,000. This ratio of the catalyst to the monomers is far smaller than that used in conventional polymerization reaction system for preparing a polar cyclic olefin polymer, however it is sufficient to exhibit catalytic activity in the method of the present invention for preparing a high molecular weight of a cyclic olefin polymer. Preferably, the molar ratio of the catalyst system to the monomers is in the range of 1:5,000-1:20,000, and more preferably 1:10,000-1:15,000.

When the molar ratio of the procatalyst to the monomer is greater than 1:2,500, it is difficult to remove the catalyst residue in polymer. When the molar ratio of the procatalyst to the monomer is less than 1:200,000, the catalytic activity is low.

A norbornene addition polymer having a polar functional group produced using the method of the present embodiment includes at least 0.1-99.9 mol % of a norbornene-based monomer having a polar functional group, in which the norbornene having a polar functional group is composed of a mixture of endo and exo isomers and the deterioration of the catalytic activity by endo-isomers containing polar functional groups can be avoided and thus a composition ratio of the mixture is not critical for polymerization performance. In the method, the monomer solution may further include cyclic olefin having non-polar functional group.

In accordance with the method of the invention, a homopolymer is prepared by polymerizing same norbornene-based monomer containing a polar functional group, or a copolymer including di-, tri- and multi-copolymers is prepared by polymerizing different polar functional norbornene-based monomers, or a copolymer including di-, tri- and multi-copolymers is prepared by polymerizing a polar functional norbornene-based monomer and a norbornene monomer having non-polar functional group.

In accordance with the method of the present invention, the cyclic olefin polymer containing polar functional groups having a molecular weight of 100,000 or more can be prepared in a yield of 40% or higher. In order to fabricate an optical film using the cycloolefin polymer, the molecular weight of the cycloolefin polymer is preferably controlled to 100,000-1,000,000. To control the molecular weight, a linear or branched cyclic C₁₋₂₀ olefin may be further used. Examples of the olefin include 1-hexene, 1-octene, cyclopentene, ethylene, etc. Such an olefin is added to the end of extending polymer chain and a β-hydrogen of the added olefin is easily eliminated, thereby producing a polymer having a desirable molecular weight.

In conventional polymerization system, cyclic olefin polymers containing polar functional groups is prepared in a very low yield and in a low molecular weight, whereas the present method produces a high molecular weight of a cycloolefin polymer containing polar functional groups in a high yield.

A cyclic olefin polymer having a polar group according to the embodiment of the present invention is provided. Preferably, a norbornene-based polymer having a polar functional group produced according to the method of the previous embodiment is an addition-polymer of a cyclic olefinic monomer represented by formula (3) and has a weight average molecular weight (M_{w}) of 10,000-1,000,000.

When the weight average molecular weight is less than 10,000, a brittle film can be produced. When the weight average molecular weight is greater than 1,000,000, it is difficult to dissolve the polymer in an organic solvent, and thus the processibility is poor.

The norbornene-based polymer containing polar functional groups prepared in accordance with the method of the present invention is transparent, has sufficient adhesion to metals or polymers containing different polar functional groups, thermal stability and strength, and exhibits a low dielectric constant sufficient to be used as insulating electronic materials. The cyclic olefin polymer produced by the present invention has a desirable adhesion to substrates of electronic components without requiring a coupling agent, and at the same time, a sufficient adhesion to metal substrates, e.g., Cu, Ag and Au. Further, the cyclic olefin polymer of the present invention exhibits a desirable optical properties so that it can be used as materials for protective films of polarizing plates and electronic components such integrated circuits (ICs), printed circuit boards, multichip modules, and the like.

The polymer of the present embodiment can be used to produce an optical anisotropic film capable of controlling a birefringence, which could not be produced with the conventional method.

A conformational unit of a general cyclic olefin has one or two stable rotation conditions, and thus can achieve an extended form such as polyamide having a rigid phenyl ring as a backbone. When a polar functional group is introduced into a norbornene-based polymer with an extended form, the interaction between molecules increases compared to polymers having simple forms, and thus packing of molecules has a directional order, thereby producing optical and electronic anisotropy.

The birefringence can be controlled according to the type and the amount of polar functional group in the cyclic olefin polymer. In particular, the birefringence in a direction through the film thickness is easily controlled, and thus the polymer of the present embodiment can be used to produce an optical compensation film for various modes of liquid crystal display (LCD).

The optical anisotropic film of the cyclic olefin polymer having a polar functional group can be prepared by a solution casting or can be prepared with a blend of one or more cyclic olefin polymers.

In order to prepare a film by solution casting, it is preferable to introduce a cyclic olefin polymer in a solvent in amount of 5-95% by weight, and preferably 10-60% by weight, and stirring the mixture at room temperature. The viscosity of the prepared solution is 100-10,000 cps, and more preferably 300-8000 cps for solution casting. To improve mechanical strength, heat resistance, light resistance, and manipulability of the film, additives such as a plasticizer, a anti-deterioration agent, a UV stabilizer or an antistatic agent can be added.

The optical anisotropic film thus prepared has a retardation value (Rth) of 70 to 1000 nm, as defined by the following Equation 1:

Rₜₕ=Δ(n_{y}−n_{z})×d (1)

where n_{y} is a refractive index of an in-plane fast axis measured at 550 nm, n_{z} is a refractive index toward thickness direction measured at 550 nm, and d is a film thickness.

The optical anisotropic film meets a refractive index requirement of nₓ≅n_{y}<n_{z}, in which nₓ is a refractive index of an in-plane slow axis, n_{y} is a refractive index of an in-plane fast axis, and n_{z} is a refractive index toward thickness direction, and thus can be used as a negative C-plate type optical compensation film for LCD.

Hereinafter, the present invention will be described in more detail with reference to the following Examples. However, these Examples are given for the purpose of illustration and are not to be construed as limiting the scope of the invention.

In the following Preparation Examples and Examples, all operations handling compounds sensitive to air or water were carried out using standard Schlenk technique or dry box technique. Nuclear magnetic resonance spectra were obtained using Bruker 400 and 600 spectrometers. A molecular weight and a molecular weight distribution of a polymer were determined by gel permeation chromatography (GPC) using standard polystyrene samples. Toluene, hexane and Et₂O were distilled and purified in sodium/benzophenone and CH₂Cl₂ was distilled and purified in CaH₂.

Preparation of Cocatalyst

### PREPARATION EXAMPLE 1

### Preparation of (Cy)₃PHCl

(Cy)₃P (2.02 g, 7.2 mmol; Cy=cyclohexyl) was dispersed in Et₂O (150 mL) in a 250 mL Schlenk flask. Then, anhydrous HCl (14.4 mL, 1.0 M in ether) was added to the solution at room temperature to give a white solid. After stirring for about 20 minutes, the solid was filtered through a glass filter and washed three times with Et₂O (80 mL). Thereafter, the residual solvent was removed at room temperature in vacuum to obtain (Cy)₃PHCl (86%, 1.95 g).

¹H—NMR (600 MHz, CD₂Cl₂): δ7.02˜6.23 (d, 1H, J_{H—P}=470 Hz), 2.56˜1.30 (m, 33H); ¹³C—NMR (600 MHz, CD₂Cl₂): δ28.9 (d), 28.5 (d), 26.8 (d), 25.6 (s). ³¹P—NMR (600 MHz, CD₂Cl₂): δ 22.98 (d, J_{P—H}=470 Hz).

### PREPARATION EXAMPLE 2

### Preparation of (n-Bu)₃PHCl

Bu)₃P (2.0 g, 10.0 mmol, n-Bu=n-butyl) was dispersed in Et₂O (100 mL) in a 250 mL Schlenk flask. Then, anhydrous HCl (20.0 mL, 1.0 M in ether) was added to the solution at room temperature to give a white solid. After stirring for about 20 minutes, the solid was filtered through a glass filter and washed three times with Et₂O (80 mL). Thereafter, the residual solvent was removed at room temperature in vacuum to obtain (n-Bu)₃PHCl (90%, 2.15 g).

### PREPARATION EXAMPLE 3

### Preparation of [(Cy)₃PH][B(C₆F₅)₄]

[Li][B(C₆F₅)₄] (1.0 g, 1.46 mmol) was suspended in CH₂Cl₂ (20 mL) in a 100 mL Schlenk flask and the CH₂Cl₂ (20 mL).solution of (Cy)₃PHCl (0.56 g, 1.75 mmol) prepared in Example 1 was slowly added. After stirring for 1 hour, the resulting slurry was filtered to yield a dark yellow filtrate and the solvent was removed in vacuum to obtain tricyclohexylphosphonium(tetrakispentafluorophenyl)borate
[(Cy)₃PH][B(C₆F₅)₄] (90%, 1.26 g).

¹H—NMR (600 MHz, CD₂Cl₂): δ5.32˜4.65 (d, 1H, J_{H—P}=440 Hz), 2.43˜1.33 (m, 33H); ¹³C—NMR (600 MHz, CD₂Cl₂): δ149.7, 148.1, 139.7, 139.2, 138.1, 138.0, 137.8, 136.2, 125.1, 124.9, 29.0, 28.8, 26.7 (d), 25.4 (S). ³¹P—NMR (600 MHz, CD₂Cl₂): 31.14 (d, J_{P—H}=440 Hz). ¹⁹F—NMR (600 MHz, CD₂Cl₂): −130.90, −161.51, −163.37.

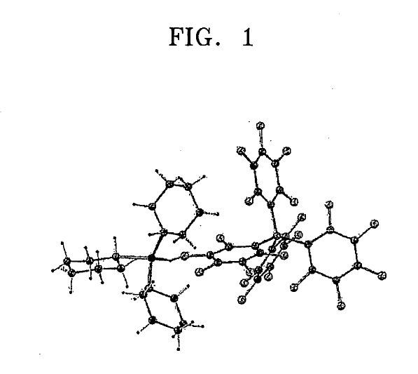

Crystals suitable for an X-ray diffraction study were grown from dichloromethane solution. The result of an X-ray crystal structure determination is presented in FIG. 1. Interestingly, the structure shows that the nonbonding interaction between the phosphorous atom of [(Cy)₃PH] part and the fluorine atom of [B(C₆F₅)₄] part exists.

### PREPARATION EXAMPLE 4

### Preparation of [(Cy)₃PH][(B(C₆F₅)₄)

[(Cy)₃PH][(B(C₆F₅)₄] was prepared in the same manner as described in Preparation Example 3, except that [Na][B(C₆F₅)₄] or [MgBr][B(C₆F₅)₄] was used instead of [Li][B(C₆F₅)₄]. The synthesis yield was about 90% similarly to Example 3.

### PREPARATION EXAMPLE 5

### Preparation of [(n-Bu)₃PH][(B(C₆F₅)₄)

[Li][B(C₆F₅)₄] (1.0 g, 1.46 mmol) was suspended in CH₂Cl₂ (20 mL) in a 100 mL Schlenk flask and the CH₂Cl₂ (20 mL) solution of (n-Bu)₃PHCl (0.42 g, 1.75 mmol) prepared in Example 2 was slowly added. After stirring for 1 hour, the resulting slurry was filtered to yield a dark yellow filtrate and the solvent was removed in vacuum to obtain tri n-butylphosphonium(tetrakispentafluorophenyl) borate [(n-Bu)₃PH][B(C₆F₅)₄] (87%, 1.12 g).

### PREPARATION EXAMPLE 6

### Preparation of [(t-Bu)₃PH][(B(C₆F₅)₄)

(t-Bu)₃P (0.35 g, 1.73 mmol, t-Bu=t-butyl) was dispersed in Et₂O (30 mL) in a 250 mL Schlenk flask. Then, anhydrous HCl (1.9 mL, 1.0 M in ether) was added to the solution at room temperature to afford a white solid. After stirring for about 20 minutes, the solid was filtered through a glass filter and washed three times with Et₂O (30 mL). Thereafter, the residual solvent was removed at room temperature in vacuum to obtain (t-Bu)₃PHCl as a white solid.

(t-Bu)₃PHCl was dissolved in CH₂Cl₂ (10 mL). In a glove box, [Li][B(C₆F₅)₄] (1.07 g, 1.56 mmol) was placed in a 100 mL schlenk flask and dissolved in CH₂Cl₂ (20 mL). Then, the (t-Bu)₃PHCl solution was added dropwise to the [Li][B(C₆F₅)₄] solution. After stirring for 1 hour, the resulting slurry was filtered to yield a green filtrate and the solvent was removed in vacuum to obtain tri
t-butyl phosphonium(tetrakispentafluorophenyl)borate [(t-Bu)₃PH][B(C₆F₅)₄] (67%, 1.05 g).

¹H—NMR (600 MHz, CD₂Cl₂): δ5.34˜4.63 (d, 1H, J_{H—P}=440 Hz), 1.61 (d, 27H); ¹³C—NMR (600 MHz, CD₂Cl₂): δ149.5, 147.9, 139.6, 138.0, 137.7, 136.0, 124.4, 38.3, 30.4. ³¹P—NMR (600 MHz, CD₂Cl₂): 63.0 (d, J_{P—H}=440 Hz). ¹⁹F—NMR (600M Hz, CD₂Cl₂): −133.3, −163.9, −167.8.

### PREPARATION EXAMPLE 7

### Preparation of [(Et)₃PH][(B(C₆F₅)₄)

(Et)₃P (0.8 g, 6.77 mmol; Et =ethyl) was dispersed in Et₂O (50 mL) in a 250 mL Schlenk flask. Then, anhydrous HCl (7.4 mL, 1.0 M in ether) was added to the solution at room temperature to afford a white solid. After stirring for about 20 minutes, the solid was filtered through a glass filter and the resultant was washed with hexane (30 mL). Thereafter, the residual solvent was removed at room temperature in vacuum to obtain (Et)₃PHCl as a white solid.

(Et)₃PHCl was dissolved in CH₂Cl₂ (10 mL). In a glove box, [Li][B(C₆F₅)₄] (4.41 g, 6.43 mmol) was placed in a 100 mL Schlenk flask and dissolved in CH₂Cl₂ (50 mL). Then, the (Et)₃PHCl solution was added dropwise to the [Li][B(C₆F₅)₄] solution. After stirring for 1 hour, the resulting slurry was filtered to yield a green filtrate and the solvent was removed in vacuum to obtain
triethylphosphonium(tetrakispentafluorophenyl)borate [(Et)₃PH][B(C₆F₅)₄] (54%, 2.91 g).

¹H—NMR (600 MHz, CD₂Cl₂): δ6.06 (m, 0.5H), 5.30 (m, 0.5H), 2.28 (m, 6H), 1.40 (m, 9H); ¹³C—NMR (600 MHz, CD₂Cl₂): δ149.5, 147.9, 139.7, 138.0, 137.9, 137.7, 136.1, 124.6, 10.6 (d), 6.8 (d). ³¹P—NMR (600 MHz, CD₂Cl₂): 26.3 (d). ¹⁹F—NMR (600 MHz, CD₂Cl₂): −133.5, −163.7, −167.8.

Preparation of Cyclic Olefin Addition-Polymers

### EXAMPLE 1

### Polymerization of 5-norbornene-2-allylacetate

5-norbornene-2-allylacetate (NB—CH₂—O—C(O)—CH₃) (5 mL, 30.9 mmol, NB=norbornene) and toluene (18 mL) were charged into a 250 mL Schlenk flask. Palladium acetate (Pd(OAc)₂)(OAc=acetate, 0.46 mg, 2.06 μmol) and [(Cy)₃PH][(B(C₆F₅)₄] (5.0 mg, 5.2 μmol) were dissolved in CH₂Cl₂ (1 mL) and added to the monomer solution. While the reaction mixture was stirred for 18 hours at 90° C. the reaction mixture became viscous. After the reaction was completed, 100 ml of toluene was added into the viscous solution to dilute it. The solution was poured into an excess of ethanol to precipitate a white polymer, which was filtered through a glass funnel, washed with ethanol, and dried in vacuo at 80° C. for 24 hours to yield 5-norbornene-2-allylacetate polymer (4.73 g: 92.2% by weight based on the total weight of used monomers). The weight average molecular weight (Mw) of the polymer was 250,071 and Mw/Mn was 2.70.

### EXAMPLE 2

### Polymerization of 5-norbornene-2-allylacetate

A polymer of 5-norbornene-2-allylacetate was obtained in the same manner as described in Example 1, except that Pd(OAc)₂ (0.14 mg, 0.62 μmol) and [(Cy)₃PH][(B(C₆F₅)₄) (1.2 mg, 1.24 μmol) were used and the polymerization temperature was 100° C. The resulting polymer was obtained in 4.00 g of yield (78% by weight based on the total weight of used monomers). The weight average molecular weight (Mw) of the polymer was 262,149 and Mw/Mn was 2.09.

### EXAMPLE 3

### Copolymerization of 5-norbornene-2-allylacetate and 5-butylnorbornene

5-norbornene-2-allylacetate (NB—CH₂—O—C(O)—CH₃) (5 mL, 30.9 mmol), 5-butylnorbornene (1.3 mL, 7.7 mmol), and toluene (7.3 mL) were charged into a 250 mL Schlenk flask. Pd(OAc)₂ (0.17 mg, 0.77 μmol) and [(Cy)₃PH][(B(C₆F₅)₄) (1.48 mg, 1.55 μmol) were dissolved in CH₂Cl₂ (1 mL) and added to the monomer solution. While the reaction mixture was stirred for 18 hours at 90° C. the reaction mixture became viscous. After the reaction was completed, 120 ml of toluene was added into the viscous solution to dilute it. The solution was poured into an excess of ethanol to precipitate a white polymer, which was filtered through a glass funnel, washed with ethanol, and dried in vacuo at 80° C. for 24 hours to yield 5-norbornene-2-allylacetate/5-butylnorbornene copolymer (4.35 g: 69.2% by weight based on the total weight of used monomers). The weight average molecular weight (Mw) of the copolymer was 303,550 and Mw/Mn was 2.16.

### EXAMPLE 4

### Copolymerization of 5-norbornene-2-allylacetate and 5-butylnorbornene

5-norbornene-2-allylacetate and 5-butylnorbornene were copolymerized in the same manner as described in Example 3, except that Pd(OAc)₂ (0.09 mg, 0.39 μmol) and [(Cy)₃PH][(B(C₆F₅)₄) (0.74 mg, 0.77 μmol) were used. The resulting polymer was obtained in 2.9 g of yield (46% by weight based on the total weight of used monomers). The weight average molecular weight (Mw) of the polymer was 362,680 and Mw/Mn was 1.96.

### EXAMPLE 5

### Copolymerization of 5-norbornene-2-allylacetate, 5-butylnorbornene and 5-norbornene-2-carboxylic methylester

5-norbornene-2-allylacetate (5 mL, 30.9 mmol), 5-butylnorbornene (1.2 mL, 6.6 mmol), 5-norbornene-2-carboxylic methylester (1 mL, 6.6 mmol) and toluene (12.4 mL) were charged into a 250 mL Schlenk flask. Pd(OAc)₂ (0.66 mg, 2.94 μmol) and [(Cy)₃PH][(B(C₆F₅)₄) (5.65 mg, 5.88 μmol) were dissolved in CH₂Cl₂ (1 mL) and added to the monomer solution. While the reaction mixture was stirred for 18 hours at 90° C. the reaction mixture became viscous. After the reaction was completed, 120 ml of toluene was added into the viscous solution to dilute it. The solution was poured into an excess of ethanol to precipitate a white polymer, which was filtered through a glass funnel, washed with ethanol, and dried in vacuo at 80□ for 24 hours to yield 5-norbornene-2-allylacetate/5-butylnorbornene/5-norbornene-2-carboxylic methylester polymer (6.45 g: 90.5% by weight based on the total weight of used monomers). The weight average molecular weight (Mw) of the polymer was 211,891 and Mw/Mn was 2.67.

### EXAMPLE 6

### Copolymerization of 5-norbornene-2-allylacetate, 5-butylnorbornene and 5-norbornene-2-carboxylic methylester

5-norbornene-2-allylacetate, 5-butylnorbornene and 5-norbornene-2-carboxylic methylester were copolymerized in the same manner as in Example 5, except that Pd(OAc)₂ (0.20 mg, 0.88 μmol) and [(Cy)₃PH][(B(C₆F₅)₄) (1.70 mg, 1.77 μmol) were used. The resulting polymer was obtained in 3.3 g of yield (46.7% by weight based on the total weight of used monomers). The weight average molecular weight (Mw) of the polymer was 261,137 and Mw/Mn was 2.01.

### EXAMPLES 7-13

### Polymerization of 5-norbornene-2-allylacetate

Polymers of 5-norbornene-2-allylacetate were prepared in the same manner as described in Example 1, except that the molar ratios of [(Cy)₃PH][(B(C₆F₅)₄) to Pd(OAc)₂ were changed to 2:1, 1:1, 2:3, 1:2, 1:4 and 1:8.
5-norbornene-2-allylacetate (4 mL, 24.7 mmol) and toluene (12 mL) were used and polymerization temperature and time were 90° C. and 4 hours, respectively. The results are shown in Table 1 below.

TABLE 1

| | | [HP(Cy)₃] | Pd/B | | | | |
|---|---|---|---|---|---|---|---|
| | Pd(OAc)₂ | [B(C₆F₅)₄] | (molar | Yield | | | |
| | (mg) | (mg) | ratio) | [g] | [%] | Mw | Mw/Mn |
| Example 7 | 1.1 | 2.4 | 2/1 | 1.77 | 43.2 | 333,400 | 2.11 |
| Example 8 | 1.1 | 4.7 | 1/1 | 3.52 | 86.0 | 272,800 | 2.28 |
| Example 9 | 1.1 | 7.1 | 2/3 | 3.82 | 93.2 | 260,000 | 2.56 |
| Example 10 | 1.1 | 9.5 | 1/2 | 3.83 | 93.4 | 256,300 | 2.49 |
| Example 11 | 1.1 | 19.0 | 1/4 | 3.80 | 90.5 | 221,600 | 2.45 |
| Example 12 | 1.1 | 28.4 | 1/6 | 3.39 | 82.7 | 194,100 | 2.25 |
| Example 13 | 1.1 | 38.0 | 1/8 | 3.30 | 80.5 | 193,200 | 2.20 |

### EXAMPLE 14-16

### Polymerization of 5-norbornene-2-allylacetate

5-norbornene-2-allylacetate was polymerized together with cyclopentene in molar ratios of cyclopentene to 5-norbornene-2-allylacetate of 10:1, 5:1 and 7:3. 5-norbornene-2-allylacetate (10 mL, 61.7 mmol) and toluene (20 mL) were charged onto a 250 mL Schlenk flask. Pd(OAc)₂ was used in a molar ratio of 1:5000 based on total amount of cyclopentene and the monomer and the molar ratio of [(Cy)₃PH][(B(C₆F₅)₄) to Pd(OAc)₂ was 2:1. The experimental procedure was carried out in the same manner as described in Example 1 and the result was shown in Table 2.

TABLE 2

| | Monomer/ | | | | | | |
|---|---|---|---|---|---|---|---|
| | Cp (molar | | Pd(OAc)₂ | | | | |
| | ratio) | Cp(mL) | (mg) | Yield | Mw | Mn | Mw/Mn |
| Example 14 | 10/1 | 0.54 | 3.1 | 9.7 g | 136,701 | 56,387 | 2.42 |
| | | | | (91%) | | | |
| Example 15 | 5/1 | 1.4 | 3.5 | 9.4 g | 76,135 | 28,945 | 2.63 |
| | | | | (83.2%) | | | |
| Example 16 | 7/3 | 2.3 | 4.0 | 9.2 g | 62,607 | 25,584 | 2.45 |
| | | | | (76%) | | | |

### EXAMPLE 17

### Polymerization of 5-norbornene-2-allylacetate

5-norbornene-2-allylacetate (10 mL, 61.7 mmol) and wet toluene (35 mL) were charged into a 250 mL Schlenk flask in air. Pd(OAc)₂ (0.92 mg, 4.11 μmol) and [(Cy)₃PH][(B(C₆F₅)₄) (7.9 mg, 8.23 μmol) were dissolved in CH₂Cl₂ (1 mL) and added to the monomer solution. While the reaction mixture was stirred for 18 hours at 90° C. the reaction mixture became viscous. After the reaction was completed, 120 ml of toluene was added into the viscous solution to dilute it. The solution was poured into an excess of ethanol to precipitate a white polymer, which was filtered through a glass funnel, washed with ethanol, and dried in vacuo at 80° C. for 24 hours to yield a 5-norbornene-2-allylacetate polymer (9.74 g: 95% by weight based on the total weight of used monomers). The weight average molecular weight (Mw) of the polymer was 271,010 and Mw/Mn was 2.40.

### EXAMPLES 18-20

### Polymerization of 5-norbornene-2-allylacetate

5-norbornene-2-allylacetate was polymerized in the same manner as described in Example 17, except that the relative amounts of a toluene and a catalyst over a monomer were varied. The results were shown in Table 3.

TABLE 3

| | | Toluene/ | | | | | |
|---|---|---|---|---|---|---|---|
| | | Monomer | Monomer/ | | | | |
| | Monomer | (volumetric | catalyst | | | | |
| | (mL) | ratio) | (molar ratio) | Yield | Mw | Mn | Mw/Mn |
| Example 17 | 10 | 3.0 | 15,000 | 9.74 g | 271,000 | 113,000 | 2.40 |
| | | | | (95.0%) | | | |
| Example 18 | 10 | 2.0 | 15,000 | 9.70 g | 319,000 | 124,000 | 2.57 |
| | | | | (94.6%) | | | |
| Example 19 | 10 | 3.0 | 10,000 | 10.08 g | 287,000 | 114,000 | 2.51 |
| | | | | (98.4%) | | | |
| Example 20 | 10 | 2.0 | 10,000 | 10.04 g | 307,000 | 120,000 | 2.57 |
| | | | | (98.0%) | | | |

### EXAMPLES 21-23

### Polymerization of 5-norbornene-2-allylacetate

5-norbornene-2-allylacetate (3 mL, 18.5 mmol) and toluene (11 mL) were charged onto a 250 mL Schlenk flask and a 1.23 mM of the catalysts solution in CH₂Cl₂ was prepared in a 2:1 ratio of [(Cy)₃PH][(B(C₆F₅)₄] to Pd(OAc)₂. The catalyst solution was used in polymerization after aging for 24, 32, and 48 hours. The subsequent experimental procedure was carried out in the same manner as described in Example 1 and the result was shown in Table 4.

TABLE 4

| | Aging time | Yield | | | |
|---|---|---|---|---|---|
| | (hr) | (%) | Mw | Mn | Mw/Mn |
| Example 21 | 24 | 93.2 | 288,395 | 126,503 | 2.28 |
| Example 22 | 32 | 86.0 | 304,280 | 144,515 | 2.11 |
| Example 23 | 48 | 94.3 | 284,763 | 131,954 | 2.16 |

The catalyst solution containing [(Cy)₃PH][(B(C₆F₅)₄) was observed to kept yellow color even after aging for 48 hours. As shown in Table 4, the polymerization yield was 90% or greater and the molecular weight was 250,000-290,000. The catalyst including [(Cy)₃PH][(B(C₆F₅)₄) maintained good catalytic activity and good stability even after aging time.

### EXAMPLES 24-25

### Polymerization of 5-norbornene-2-allylacetate

5-norbornene-2-allylacetate (5 mL, 30.9 mmol) and toluene (18 mL) were charged into a 250 mL Schlenk flask. Pd(OAc)₂ (0.46 mg, 2.06 μmol) and [(Cy)₃PH][(B(C₆F₅)₄) (5.0 mg, 5.2 μmol) were dissolved in CH₂Cl₂ (1 mL) and added to the monomer solution. The polymerization was carried out at 80° C. and 150° C. for 18 hours. The subsequent processes were carried out in the same manner as in Example 1 to obtain a 5-norbornene-2-allylacetate polymer and the results were shown in Table 5. For reference, the results of Example 1 were also added.

TABLE 5

| | Polymerization | Yield | | | |
|---|---|---|---|---|---|
| | temperature (° C.) | (%) | Mw | Mn | Mw/Mn |
| Example 1 | 90 | 92.2 | 250,071 | 92,619 | 2.70 |
| Example 24 | 80 | 83.0 | 312,300 | 138,200 | 2.26 |
| Example 25 | 150 | 85.0 | 145,000 | 62,000 | 2.34 |

### COMPARATIVE EXAMPLES 1-3

### Polymerization of 5-norbornene-2-allylacetate

A catalyst system including Pd(OAc)₂, dimethylanilium
(tetrakispentafluorophenyl)borate ([PhNMe₂H][B(C₆F₅)₄]) and P(Cy)₃ was used. The molar ratio of [PhNMe₂H][B(C₆F₅)₄] to Pd(OAc)₂ was 2:1 and the molar ratio of P(Cy)₃ to Pd(OAc)₂ was 1:1. These catalyst components were dissolved in CH₂Cl₂ to prepare a 1.23 mM orange catalyst solution. Polymerization was carried out in the same manner as described in Examples 21-23. The results were shown in Table 6.

TABLE 6

| | Aging time | Yield | | | |
|---|---|---|---|---|---|
| | (hr) | (%) | Mw | Mn | Mw/Mn |
| Comparative | 24 | 81.7 | 289,461 | 135,137 | 2.14 |
| Example 1 | | | | | |
| Comparative | 32 | 32.7 | 300,643 | 145,393 | 2.07 |
| Example 2 | | | | | |
| Comparative | 48 | 2.60 | 233,495 | 116,726 | 2.00 |
| Example 3 | | | | | |

The catalyst solution including [PhNMe₂H][B(C₆F₅)₄] turned from orange to green in color after 10 minutes. When polymerization was carried out using the green catalyst solution, the polymerization yield was 80% after aging for 24 hours and was reduced to 10% or less after aging for 48 hours. As a result, catalyst solutions of Comparative Examples 1-3 including [PhNMe₂H][B(C₆F₅)₄] are less stable than catalyst solutions of Examples 21-23 including [(Cy)₃PH][(B(C₆F₅)₄).

### COMPARATIVE EXAMPLE 4

### Polymerization of 5-norbornene-2-allylacetate

[Li][B(C₆F₅)₄] (20.6 mg, 0.0030 mmol) and 5-norbornene-2-allylacetate (5.0 g, 30 mmol) were charged into a 250 mL Schlenk flask. A solution of [(Allyl)PdCl]₂ (0.55 mg, 0.0015 mmol) and P(Cy)₃ (0.84 mg, 0.0030 mmol) in toluene (0.1 mL) was added into the flask. Polymerization was carried out at 90° C. for 18 hours and the resulting solution was added into an excess amount of ethanol to precipitate polymeric materials. However, no polymer was obtained.

### COMPARATIVE EXAMPLE 5

### Polymerization of 5-norbornene-2-carboxylic methylester

5-norbornene-2-carboxylic methylester (MENB(NB—C(O)—O—CH₃) (5 mL, 34.4 mmol) and toluene (18 mL) were charged into a 250 mL Schlenk flask. A CH₂Cl₂ solution (1 mL) of Pd(OAc)₂ (0.772 mg, 3.44 μmol) and [HP(Cy)₃][(B(C₆F₅)₄) (6.61 mg, 6.88 μmol) was added into the monomer solution via a syringe at 90° C. Polymerization reaction was carried out at 90° C. for 18 hours. Thereafter, the resulting solution was added into an excess amount of ethanol to obtain white polymer precipitates. The precipitates were filtered through a glass filter to recover a polymer. The polymer was dried in a vacuum oven at 80° C. for 24 hours to obtain 5-norbornene-2-carboxylic methylester polymer (0.8 g: 15% by weight based on the total weight of used monomers).

### COMPARATIVE EXAMPLE 6

### Polymerization of 5-norbornene-2-carboxylic butylester

5-norbornene-2-carboxylic butylester (MENB(NB—C(O)—O—CH₂CH₂CH₂CH₃) (5 mL, 34.4 mmol) and toluene (17 mL) were charged into a 250 mL Schlenk flask. A CH₂Cl₂ solution (1 mL) of Pd(OAc)₂ (0.56 mg, 2.51 μmol) and [HP(Cy)₃][(B(C₆F₅)₄) (4.82 mg, 5.02 μmol) was added into the monomer solution via a syringe at 90° C. Polymerization reaction was carried out at 90° C. for 18 hours. Thereafter, the resulting solution was added into an excess amount of ethanol. However, no polymer was obtained.

### COMPARATIVE EXAMPLE 7

### Polymerization of 5-norbornene-2-allylacetate

5-norbornene-2-allylacetate (5 mL, 30.9 mmol) and toluene (18 mL) were charged into a 100 mL Schlenk flask. Pd(OAc)₂ (0.69 mg, 3.09 μmol) and [HP(Cy)₃][(B(C₆F₅)₄) (5.94 mg, 6.18 μmol) were dissolved in CH₂Cl₂ (1 mL) and then AlEt₃ (18.5 μl, 18.5 μmol) was added there. Immediately the solution turns black in color. The black catalyst solution was added to the monomer solution. Polymerization was carried out at 90° C. for 18 hours. Thereafter, the resulting solution was added to ethanol. However, no polymer was obtained.

### COMPARATIVE EXAMPLE 8

### Polymerization of 5-norbornene-2-allylacetate

5-norbornene-2-allylacetate (5 mL, 30.9 mmol) and toluene (18 mL) were charged into a 100 mL Schlenk flask. Pd(OAc)₂ (0.69 mg, 3.09 μmol) and [PhNMe₂H][B(C₆F₅)₄] (5.94 mg, 6.18 μmol) as catalysts were dissolved in CH₂Cl₂ (1 mL), and then a colorless (Cy)₃P·AlEt₃ complex solution including Cy₃P (0.87 mg, 3.09 μmol) and AlEt₃ (3.09 μl, 3.09 μmol) was added there. Immediately the solution turns black in color. The black catalyst solution was added to the monomer solution. Polymerization was carried out at 90° C. for 18 hours. Thereafter, the resulting solution was added into excess ethanol to obtain white polymer precipitates. The precipitate was filtered through a glass filter and dried in a vacuum oven at 80° C. for 24 hours to obtain a polymer (0.5 g: 10% by weight based on the total weight of used monomers).

### COMPARATIVE EXAMPLE 9 and 10

### Polymerization of 5-norbornene-2-allylacetate

5-norbornene-2-allylacetate (5 mL, 30.9 mmol) and toluene (18 mL) were charged into a 250 mL Schlenk flask. Pd(OAc)₂ (0.46 mg, 2.06 μmol) and [(Cy)₃PH][(B(C₆F₅)₄) (5.0 mg, 5.2 μmol) were dissolved in CH₂Cl₂ (1 mL) and added to the monomer solution. The polymerization was carried out at 50° C. and 170° C. for 18 hours. The subsequent processes were carried out in the same manner described as in Example 1. The results were shown in Table 7.

TABLE 7

| | Polymerization | Yield | | | |
|---|---|---|---|---|---|
| | temperature (° C.) | (%) | Mw | Mn | Mw/Mn |
| Comparative | 50 | 18.0 | 265,000 | 120,400 | 2.20 |
| Example 9 | | | | | |
| Comparative | 170 | 34.0 | 105,000 | 42,800 | 2.45 |
| Example 10 | | | | | |

As can be seen in Table 7, as polymerization temperatures such as 50 and 170° C. are not within the range defined above, polymerization yields are considerably reduced. The reason for this is as described above.

Preparation of Optical Anisotropic Film

### EXAMPLES 26 AND 27

Each of the polymers prepared in Examples 1 and 3 was mixed with a solvent to form a coating solution as shown in Table 8. The coating solutions were cast on a glass substrate using a knife coater or a bar coater, and then the substrate was dried at room temperature for 1 hour and further dried under a nitrogen atmosphere at 100° C. for 18 hours. The glass substrate was kept at −10° C. for 10 seconds and the film on the glass plate was peeled off to obtain a clear film having an uniform thickness. The thickness deviation of the film was less than 2%. The thickness and the light transmittance of the obtained film were shown in Table 8

TABLE 8

| | Composition of | | Physical properties | |
|---|---|---|---|---|
| | film solution | | of film | |
| | Polymer | Solvent | | Light |
| | (parts | (parts | Thickness | transmittance |
| | by weight) | by weight) | (μm) | (%) |
| Example 26 | Polymer | THF 560 | 114 | 92 |
| | prepared in | | | |
| | Example 1 | | | |
| Example 27 | Polymer | CH₂Cl₂ 360 | 120 | 92 |
| | prepared in | and TOLUENE | | |
| | Example 3 | 200 | | |

In Table 8, THF is tetrahydrofurane.

Measurement of Optical Anisotropy

### EXPERIMENTAL EXAMPLE 1 AND 2

For clear films produced in Examples 26 and 27, a refractive index n was measured using an Abbe refractometer, an in-plane retardation value Re was measured using an automatic birefringence analyzer (available from Oji Scientific Instrument; KOBRA-21 ADH), and a retardation value R_{θ} was measured when the angle between incident light and the film surface was 50° and a retardation value Rₜₕ between the direction through the film thickness and the in-plane x-axis was calculated using Equation (2):

$${R}_{th} = \frac{{R}_{θ} \times cos {θ}_{f}}{{sin}^{2} {θ}_{f}} . \qquad ( 2 )$$

A refractive index difference (nₓ−n_{y}) and a refractive index difference (n_{y}−n_{z}) were calculated by dividing Rₑ and Rₜₕ by the film thickness. (nₓ−n_{y}), R_{θ}, Rₜₕ and (n_{y}−n_{z}) of each clear film were indicated in Table 9.

TABLE 9

| | n | | | |
|---|---|---|---|---|
| | (refractive | (nₓ − n_{y}) × | | (n_{y} − n_{z}) × |
| | index) | 10³ | Rₜₕ(nm/μm) | 10³ |
| Experimental | 1.52 | 0.008 | 2.32 | — |
| Example 1 | | | | |
| Experimental | 1.50 | 0.009 | 2.13 | 2.13 |
| Example 2 | | | | |

When films were covered with a triacetate cellulose film having n_{y}>n_{z}, R_{θ} values of all cyclic olefin films increased, which indicates that Rₜₕ of a cyclic olefin film is produced due to a negative birefringence (n_{y}>n_{z}) in a direction through the film thickness.

According to the olefin polymerization method, deactivation of a catalyst due to a polar functional group of a monomer can be prevented, and thus a polyolefin having a high molecular weight can be prepared with a high yield, and the ratio of catalyst to monomer can be less than 1/5000 due to good activity of the catalyst, and thus removal of catalyst residues is not required.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of producing cyclic olefin polymers having polar functional groups, the method comprising:
preparing a catalyst mixture including
i) a procatalyst represented by formula (1) containing a group 10 metal and a ligand containing hetero atoms bonded to the metal;
ii) a cocatalyst represented by formula (2) including a salt compound which is capable of providing a phosphonium cation and an anion weakly coordinating to the metal of the procatalyst; and
addition-polymerizing cyclic olefin monomers having polar functional groups in the presence of an organic solvent and the catalyst mixture, at a temperature of 80-150° C.: 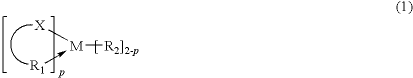
where X is a hetero atom selected from S, O and N;
R₁ is —CH═CHR²⁰, —OR²⁰, —SR²⁰, —N(R²⁰)₂, —N═NR²⁰, —P(R²⁰)₂, —C(O)R²⁰, —C(R²⁰)═NR²⁰, —C(O)OR²⁰, —OC(O)OR²⁰, —OC(O)R²⁰, —C(R²⁰)═CHC(O)R²⁰, —R²¹C(O)R²⁰, —R²¹C(O)OR²⁰ or —R²¹OC(O)R²⁰, in which R²⁰ is a hydrogen, a halogen, a linear or branched C₁₋₅ alkyl, a linear or branched C₁₋₅ haloalkyl, a linear or branched C₅₋₁₀ cycloalkyl, a linear or branched C₂₋₅ alkenyl, a linear or branched C₂₋₅ haloalkenyl, or an optionally substituted C₇₋₂₄ aralkyl, and R²¹ is a C₁₋₂₀ hydrocarbylene;
R₂ is a linear or branched C₁₋₂₀ alkyl, alkenyl or vinyl, a C₅₋₁₂ cycloalkyl optionally substituted by a hydrocarbon; a C₆₋₄₀ aryl optionally substituted by a hydrocarbon; a C₇₋₁₅ aralkyl optionally substituted by a hydrocarbon; or C₃₋₂₀ alkynyl;
M is a Group 10 metal; and
p is an integer from 0 to 2, and
[(R₃)—P(R₄)ₐ(R_{4′})_{b}[Z(R₅)_{d}]_{c}][Ani] (2)
where each of a, b and c is an integer from 0 to 3, and a+b+c=3;
Z is O, S, Si or N;
d is 1 when Z is O or S, d is 2 when Z is N, and d is 3 when Z is Si;
R₃ is a hydrogen, an alkyl, or an aryl;
each of R₄, R_{4′} and R₅ is a hydrogen; a linear or branched C₁₋₂₀ alkyl, alkoxy, allyl, alkenyl or vinyl; a C₃₋₁₂ cycloalkyl optionally substituted by a hydrocarbon; a C₆₋₄₀ aryl optionally substituted by a hydrocarbon; a C₇₋₁₅ aralkyl optionally substituted by a hydrocarbon; a C₃₋₂₀ alkynyl; a tri(linear or branched C₁₋₁₀ alkyl)silyl; a tri(linear or branched C₁₋₁₀ alkoxy)silyl; a tri(optionally substituted C₃₋₁₂ cycloalkyl)silyl; a tri(optionally substituted C₆₋₄₀ aryl)silyl; a tri(optionally substituted C₆₋₄₀ aryloxy)silyl; a tri(linear or branched C₁₋₁₀ alkyl)siloxy; a tri(optionally substituted C₃₋₁₂ cycloalkyl)siloxy; or a tri(optionally substituted C₆₋₄₀ aryl)siloxy, in which each substituent is a halogen or C₁₋₂₀ haloalkyl; and
[Ani] is an anion capable of weakly coordinating to the metal M of the procatalyst represented by formula (1) and is selected from the group consisting of borate, aluminate, [SbF₆]—, [PF₆]—, [AsF₆]—, perfluoroacetate([CF₃CO₂]—), perfluoropropionate([C₂F₅CO₂]—), perfluorobutyrate([CF₃CF₂CF₂CO₂]—), perchlorate([ClO₄]—), p-toluenesulfonate([p-CH₃C₆H₄SO₃]—), [SO₃CF₃]—, boratabenzene, and carborane optionally substituted with a halogen.

2. The method of claim 1, wherein the borate or aluminate of formula (2) is an anion represented by formula (2a) or (2b):
[M′(R₆)₄] (2a),
[M′(OR₆)₄] (2b)
where M′ is B or Al;
R₆ is each independently a halogen, a linear or branched C₁₋₂₀ alkyl or alkenyl optionally substituted by a halogen, a C₃₋₁₂ cycloalkyl optionally substituted by a halogen, a C₆₋₄₀ aryl optionally substituted by a hydrocarbon, a C₆₋₄₀ aryl optionally substituted by a linear or branched C₃₋₂₀ trialkylsiloxy or a linear or branched C₁₈₋₄₈ triarylsiloxy, or a C₇₋₁₅ aralkyl optionally substituted by a halogen.

3. The method of claim 1, wherein the cyclic olefin monomer is a compound represented by formula (3): 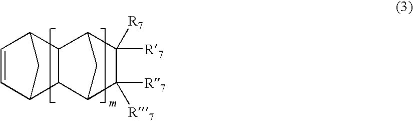
where m is an integer from 0 to 4;
at least one of R₇, R₇′, R₇″ and R₇′″ is a polar functional group and the others are nonpolar functional groups;
R₇, R₇′, R₇″ and R₇′″ can be bonded together to form a saturated or unsaturated C₄₋₁₂ cyclic group or a C₆₋₂₄ aromatic ring;
the nonpolar functional group is a hydrogen; a halogen; a linear or branched C₁₋₂₀ alkyl, haloalkyl, alkenyl or haloalkenyl; a linear or branched C₃₋₂₀ alkynyl or haloalkynyl; a C₃₋₁₂ cycloalkyl optionally substituted by an alkyl, an alkenyl, an alkynyl, a halogen, a haloalkyl, a haloalkenyl or haloalkynyl; a C₆₋₄₀ aryl optionally substituted by an alkyl, an alkenyl, an alkynyl, a halogen, a haloalkyl, a haloalkenyl or haloalkynyl; or a C₇₋₁₅ aralkyl optionally substituted by an alkyl, an alkenyl, an alkynyl, a halogen, a haloalkyl, a haloalkenyl or haloalkynyl;
the polar functional group is a non-hydrocarbonaceous polar group having at least one O, N, P, S, Si or B and is —R⁸OR₉, —OR⁹, —OC(O)OR⁹, —R⁸OC(O)OR⁹, —C(O)R⁹, —R⁸C(O)OR⁹, —C(O)OR⁹, —R⁸C(O)R⁹, —OC(O)R⁹, —R⁸OC(O)R⁹, —(R⁸O)ₖ-OR⁹, —(OR⁸)ₖ-OR⁹, —C(O)—O—C(O)R⁹, —R⁸C(O)—O—C(O)R⁹, —SR⁹, —R⁸SR⁹, —SSR⁸, —R⁸SSR⁹, —S(═O)R⁹, —R⁸S(═O)R⁹, —R⁸C(═S)R⁹, —R⁸C(═S)SR⁹, —R⁸SO₃R⁹, —SO₃R⁹, —R⁸N═C═S, —NCO, R⁸—NCO, —CN, —R⁸CN, —NNC(═S)R⁹, —R⁸NNC(═S)R⁹, —NO₂, —R⁸NO₂, 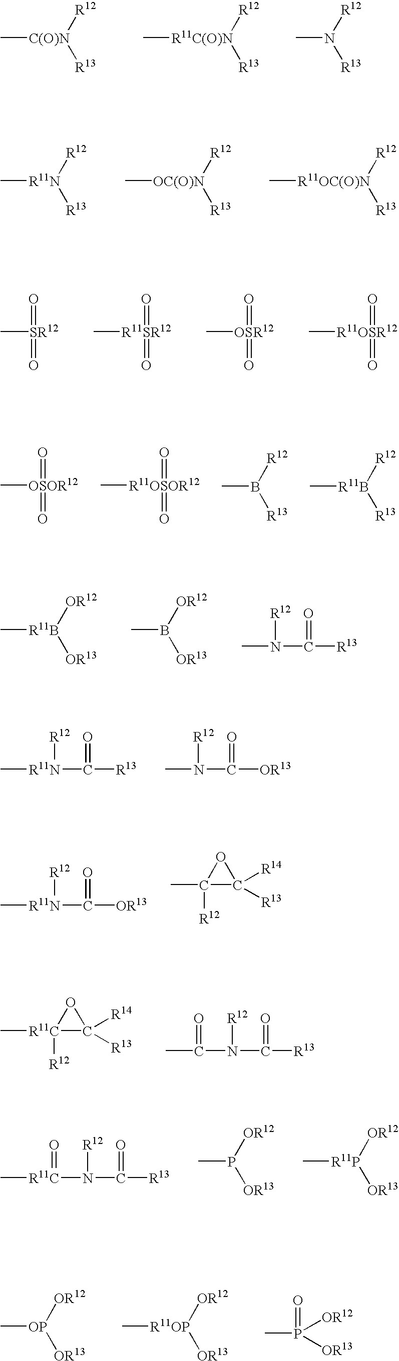 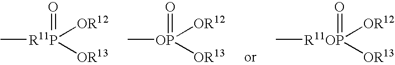
in which each of R⁸ and R¹¹ is a linear or branched C₁₋₂₀ alkylene, haloalkylene, alkenylene or haloalkenylene; a linear or branched C₃₋₂₀ alkynylene or haloalkynylene; a C₃₋₁₂ cycloalkylene optionally substituted by an alkyl, an alkenyl, an alkynyl, a halogen, a haloalkyl, a haloalkenyl or haloalkynyl; a C₆₋₄₀ arylene optionally substituted by an alkyl, an alkenyl, an alkynyl, a halogen, a haloalkyl, a haloalkenyl or haloalkynyl; or a C₇₋₁₅ aralkylene optionally substituted by an alkyl, an alkenyl, an alkynyl, a halogen, a haloalkyl, a haloalkenyl or haloalkynyl;
each of R⁹, R¹⁰, R¹² and R¹³ is a hydrogen; a halogen; a linear or branched C₁₋₂₀ alkyl, haloalkyl, alkenyl or haloalkenyl; a linear or branched C₃₋₂₀ alkynyl or haloalkynyl; a C₃₋₁₂ cycloalkyl optionally substituted by an alkyl, an alkenyl, an alkynyl, a halogen, a haloalkyl, a haloalkenyl or haloalkynyl; a C₆₋₄₀ aryl optionally substituted by an alkyl, an alkenyl, an alkynyl, a halogen, a haloalkyl, a haloalkenyl or haloalkynyl; a C₇₋₁₅ aralkyl optionally substituted by an alkyl, an alkenyl, an alkynyl, a halogen, a haloalkyl, a haloalkenyl or haloalkynyl; or an alkoxy, an haloalkoxy, a carbonyloxy or a halocarbonyloxy; and
k is an integer from 1 to 10.

4. The method of claim 1, wherein the procatalyst represented by formula (1) and the cocatalyst represented by formula (2) are a palladium compound represented by formula (4) and a phosphonium compound represented by formula (5), respectively; 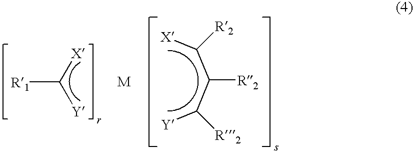
where each of X′ and Y′ is a hetero atom selected from S and O;
each of R₁′, R₂′, R₂″ and R₂′″ is a linear or branched C₁₋₂₀ alkyl, alkenyl or vinyl; a C₅₋₁₂ cycloalkyl optionally substituted by a hydrocarbon; a C₆₋₄₀ aryl optionally substituted by a hydrocarbon; a C₇₋₁₅ aralkyl optionally substituted by a hydrocarbon; or a C₃₋₂₀ alkynyl;
M is a Group 10 metal; and
each of r and s is an integer from 0 to 2 and r+s=2, and
[H—P(R₄)₃][Ani] (5)
where R₄ is a hydrogen; a linear or branched C₁₋₂₀ alkyl, alkoxy, allyl, alkenyl or vinyl; an optionally substituted C₃₋₁₂ cycloalkyl; an optionally substituted C₆₋₄₀ aryl; an optionally substituted C₇₋₁₅ aralkyl; or a C₃₋₂₀ alkynyl, in which each substituent is a halogen or a C₁₋₂₀ haloalkyl; and
[Ani] is an anion capable of weakly coordinating to the metal M of the procatalyst represented by formula (1) and is selected from the group consisting of borate, aluminate, [SbF₆]—, [PF₆]—, [AsF₆]—, perfluoroacetate([CF₃CO₂]—), perfluoropropionate([C₂F₅CO₂]—), perfluorobutyrate([CF₃CF₂CF₂CO₂]—), perchlorate([ClO₄]—), p-toluenesulfonate([p-CH₃C₆H₄SO₃]—), [SO₃CF₃]—, boratabenzene, and carborane optionally substituted by a halogen.

5. The method of claim 1, wherein the procatalyst represented by formula (1) and the cocatalyst represented by formula (2) are a palladium compound represented by formula (4a) and a phosphonium compound represented by formula (5), respectively; 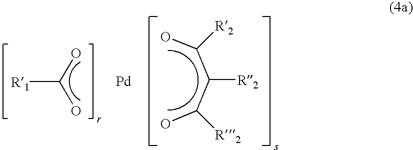
where each of R₁′, R₂′, R₂″ and R₂′″ is a linear or branched C₁₋₂₀ alkyl, alkenyl or vinyl; a C₅₋₁₂ cycloalkyl optionally substituted by a hydrocarbon; a C₆₋₄₀ aryl optionally substituted by a hydrocarbon; a C₇₋₁₅ aralkyl optionally substituted by a hydrocarbon; or a C₃₋₂₀ alkynyl; and
each of r and s is an integer from 0 to 2 and r+s=2, and
[H—P(R₄)₃][Ani] (5)
where R₄ and [Ani] are as defined in claim 4.

6. The method of claims 1, wherein in the procatalyst represented by formula (1), the metal is Pd, p is 2, and the ligand having a hetero atom directly coordinating to the metal is acetylacetonate or acetate, and in the cocatalyst including a salt compound having phosphonium represented by formula (2), b is 0, c is 0, R₃ is H, and R₄ is cyclohexyl, isopropyl, t-butyl, n-butyl or ethyl.

7. The method of claim 1, wherein a molar ratio of the cocatalyst to the procatalyst is 0.5-10:1.

8. The method of claim 1, wherein the catalyst mixture is supported on a inorganic support.

9. The method of claim 8, wherein the inorganic support is at least one selected from the group consisting of silica, titania, silica/chromia, silica/chromia/titania, silica/alumina, aluminum phosphate gel, silanized silica, silica hydrogel, montmorillonite clay and zeolite.

10. The method of claim 1, wherein an organic solvent used to dissolve the catalyst mixture is at least one solvent selected from the group consisting of dichloromethane, dichloroethane, toluene, chlorobenzene and a mixture thereof.

11. The method of claim 1, wherein a total amount of the organic solvent is 50-800% based on the weight of the total monomer in the monomer solution.

12. The method of claim 1, wherein the catalyst mixture comprises a metal catalyst complex composed of the procatalyst and the cocatalyst.

13. The method of claim 1, wherein the catalyst mixture is added in a solid phase to the monomer solution.

14. The method of claim 1, wherein the amount of the catalyst mixture is such that a molar ratio of the procatalyst to the total monomer is 1:2,500 to 1:200,000.

15. The method of claim 1, wherein the monomer solution further comprises a cyclic olefin compound having no polar functional group.

16. The method of claim 1, wherein the cyclic olefin polymers having polar functional groups comprise a cyclic olefin homopolymer, a copolymer of cyclic olefin monomers having different polar functional groups, or a copolymer of a cyclic olefin monomer having a polar functional group and a cyclic olefin monomer having no polar functional group.

17. The method of claim 1, wherein a weight average molecular weight M_{w} of the cyclic olefin polymer having a polar functional group is 10,000-1,000,000.

18. The method of claim 1, wherein the monomer solution further comprises a linear or branched C₁₋₂₀ olefin.

19. A polymer produced using the method of any one of claims 1-18, which is an addition polymer of a cyclic olefin monomer having a polar functional group represented by formula (3) and has a weight average molecular weight M_{w} of 10,000-1,000,000: 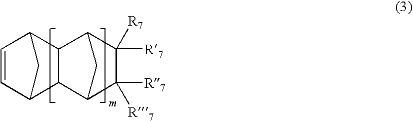
where m, R₇, R₇′, R₇″ and R₇′″ are as defined in claim 3.

20. An optical anisotropic film comprising the cyclic olefin polymer having a polar functional group of claim 19.

21. The optical anisotropic film of claim 20, which has a retardation value Rₜₕ represented by Equation (1) of 70-1000 nm:
Rₜₕ=Δ(n_{y}−n_{z})×d (1)
where n_{y} is a refractive index of an in-plane fast axis measured at 550 nm;
n_{z} is a refractive index in a direction through the film thickness measured at 550 nm, and d is a film thickness.

22. The optical anisotropic film of claim 21, which is a negative C-plate type optical compensation film for liquid crystal display, satisfying a refractive index requirement of nₓ≅n_{y}>n_{z}, in which nₓ is a refractive index of an in-plane slow axis, n_{y} is a refractive index of an in-plane fast axis, and n_{z} is a refractive index in a direction through the film thickness.
